(19) United States
(12) Patent Application Publication
(10) Pub. No.: US 2025/0271792 A1
(43) Pub. Date: Aug. 28, 2025

(54) IMAGE FORMING APPARATUS

(71) Applicant: Konica Minolta, Inc., Tokyo (JP)

(72) Inventor: Tatsuya KATAGIRI, Tokyo (JP)

(21) Appl. No.: 19/063,567

(22) Filed: Feb. 26, 2025

(30) Foreign Application Priority Data
Feb. 28, 2024 (JP) 2024-029010

(51) Int. Cl. G03G 15/20; G03G 15/00; G03G 15/01; G03G 21/20

(52) U.S. Cl. CPC G03G 15/2025; G03G 15/0189; G03G 15/2064; G03G 15/50; G03G 15/6591; G03G 15/6594; G03G 21/206

(57) ABSTRACT

The image forming apparatus includes: a fixer that heats and fixes a toner image formed on a continuous medium; a collector that collects ultra fine particles generated from an elastic member included in the fixer; an air blower that generates an air current toward a side of the collector; and a hardware processor that varies an output mode of the air blower according to at least one of an apparatus state of the image forming apparatus and/or a printing condition for the image forming apparatus.

### CROSS REFERENCE TO RELATED APPLICATIONS

Japanese Patent Application No. 2024-029010 filed on Feb. 28, 2024, including description, claims, drawings, and abstract the entire disclosure is incorporated herein by reference in its entirety.

### BACKGROUND

### Technological Field

The present invention relates to an image forming apparatus that forms an image on a continuous medium.

### Description of Related Art

In a case where a medium to be conveyed in an image forming apparatus is a continuous medium such as continuous paper (for example, roll paper), there is no interval between pieces of papers, unlike the case of flat paper. Since the continuous medium is present all the time in a fixer while image formation is in progress, the heat of the fixer is likely to be absorbed by the continuous medium. For this reason, the temperature of the fixer is set higher in the case of forming an image on a continuous medium than in the case of forming an image on flat paper.

When the temperature of the fixer is set high, numerous ultra fine particles are generated from an elastic member of the fixer. In a case where the ultra fine particles adhere to a charged electrode of an electric charger, image streaks occur in the conveyance direction, and in a case where the ultra fine particles adhere to a continuous medium, image transferability is affected and image unevenness occurs. That is, the generation of ultra fine particles from the elastic member leads to deterioration of the image quality.

For this reason, an image forming apparatus capable of removing such ultra fine particles has been developed (see Japanese Patent Application Laid-Open No. 2022-071368). The image forming apparatus described in Japanese Patent Application Laid-Open No. 2022-071368 includes: a filter (referred to as an air blowing filter in Japanese Patent Application Laid-Open No. 2022-071368) that collects ultra fine particles; and an air blowing fan that generates an air current on the side of the filter in the image forming apparatus. The air blowing fan sucks air in the image forming apparatus to the side of the filter. In other words, the air blowing fan sucks ultra fine particles included in the air in the image forming apparatus to the side of the filter.

### SUMMARY

Incidentally, in general, image formation (printing) cannot be interrupted during conveyance in the case of a continuous medium. For this reason, ultra fine particles are continuously generated from an elastic member of a fixer. Further, in the case of a continuous medium, the presence of a continuous medium at the fixer all the time while image formation is in progress reduces the air permeability of the fixer, which may therefore lead to a continuous increase in the amount of ultra fine particles floating around the fixer or inside the image forming apparatus. For this reason, it is necessary to increase the collectability of ultra fine particles by a filter by setting the output (output mode) of an air blowing fan to be high.

However, when the output of an air blowing fan increases, fan noise increases, it becomes difficult to attempt a noise reduction in the image forming apparatus, power consumption of the air blowing fan increases, and it becomes difficult to attempt energy saving for the image forming apparatus.

Accordingly, an object of the present invention is to provide an image forming apparatus capable of forming a high-quality image on a continuous medium and attempting a noise reduction and energy saving.

An aspect of an image forming apparatus according to the present invention is an image forming apparatus that forms an image on a continuous medium, and the image forming apparatus includes:
a fixer that includes an elastic member, which comes into direct or indirect contact with the continuous medium, and heats and fixes a toner image formed on the continuous medium;
a collector that collects ultra fine particles generated from the elastic member;
an air blower that generates an air current toward a side of the collector; and
a hardware processor that varies an output mode of the air blower according to at least one of an apparatus state of the image forming apparatus and/or a printing condition for the image forming apparatus.

### BRIEF DESCRIPTION OF DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a schematic diagram of an overall configuration of an image forming apparatus according to the present embodiment;

FIG. 2 is an enlarged view of a portion II in FIG. 1;

FIG. 3 is an enlarged view of a portion III in FIG. 1;

FIG. 4 is a cross-sectional view taken along a line IV-IV in FIG. 3;

FIG. 5 is a cross-sectional view taken along a line V-V in FIG. 2;

FIG. 6 is a control block diagram of the image forming apparatus according to the present embodiment; and

FIG. 7 is a flowchart for describing setting processing of an output mode of a plurality of first air blowing fans and a plurality of second air blowing fans.

### DETAILED DESCRIPTION OF EMBODIMENTS

Hereinafter, one or more embodiments of the present invention will be described with reference to the drawings. However, the scope of the invention is not limited to the disclosed embodiments.

Note that, in the specification and claims of the present application, the upstream side refers to the upstream side in the conveyance direction of a continuous medium, and the downstream side refers to the downstream side in the conveyance direction of the continuous medium.

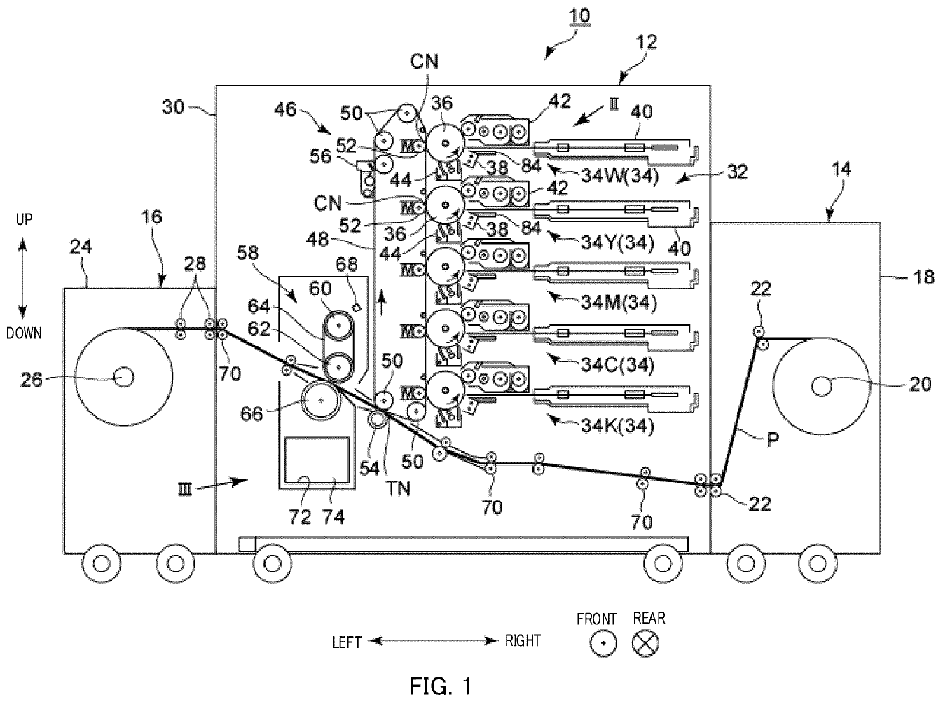

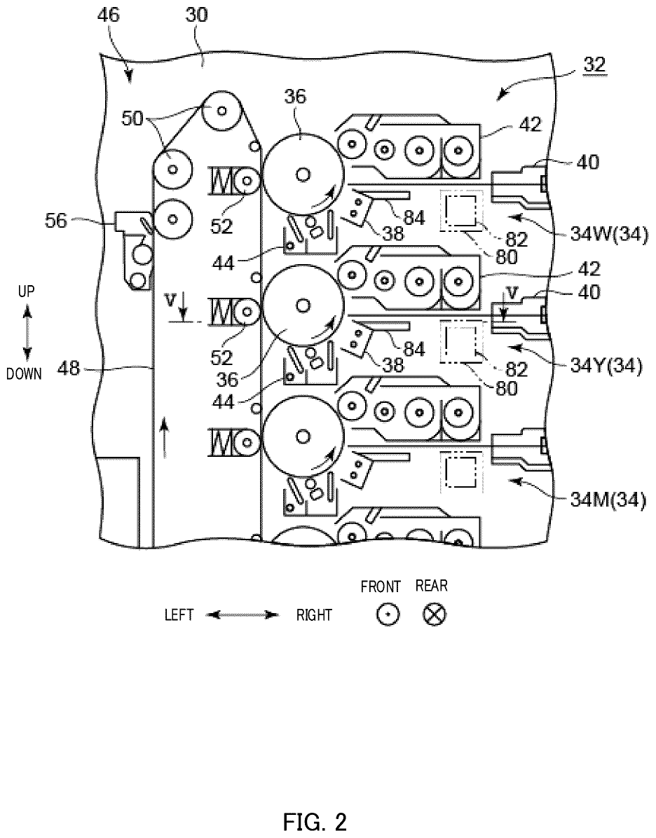

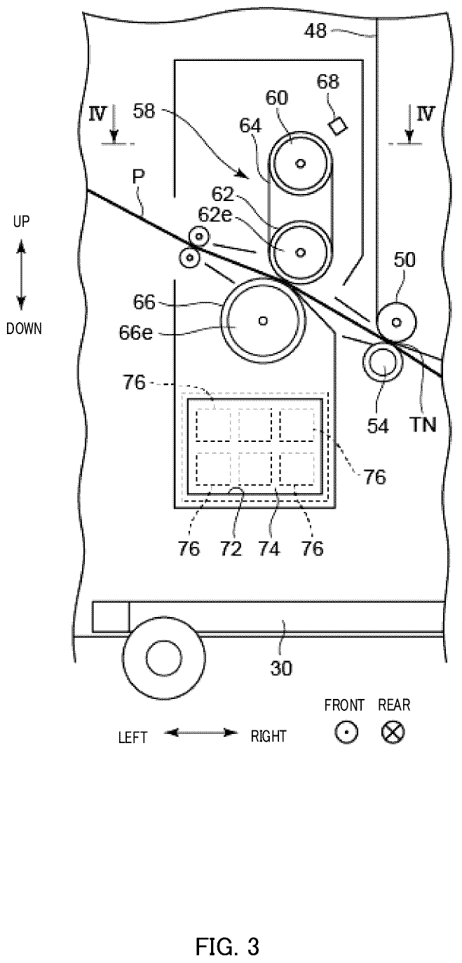

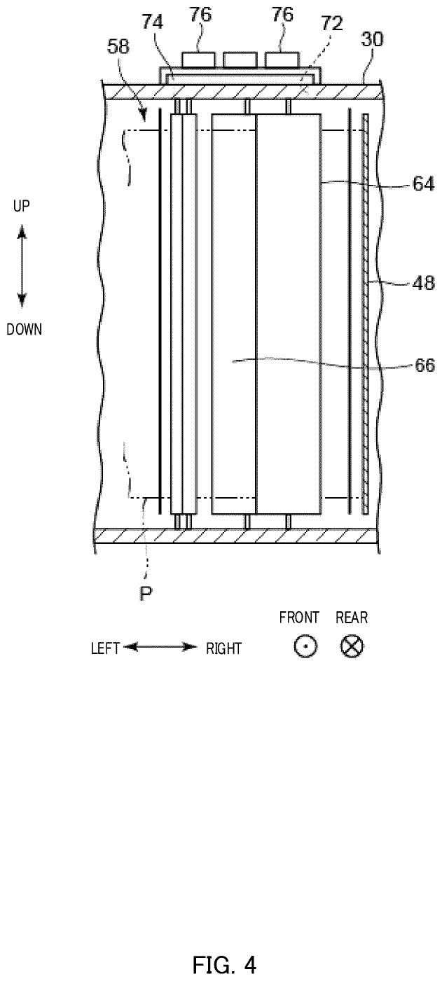

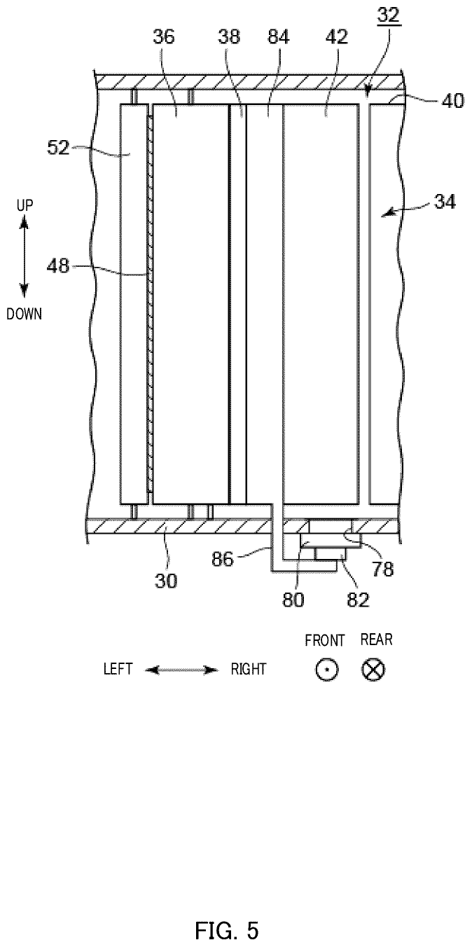

The configuration of an image forming apparatus 10 according to the present embodiment will be described with reference to FIGS. 1 to 5. FIG. 1 is a schematic diagram illustrating an overall configuration of the image forming apparatus 10 according to the present embodiment. FIG. 2 is an enlarged view of the portion II in FIG. 1. FIG. 3 is an enlarged view of the portion III in FIG. 1. FIG. 4 is a cross-sectional view taken along the line IV-IV in FIG. 3. FIG. 5 is a cross-sectional view taken along the line V-V of FIG. 2.

As illustrated in FIG. 1, the image forming apparatus 10 is a so-called tandem-type image forming apparatus, and forms (prints) an image on a continuous medium P by an electrophotographic method. As the continuous medium P, for example, continuous paper, tack paper, a polyethylene terephthalate (PET) film, or the like is used.

The image forming apparatus 10 includes: a printing machine 12 which is the main constituent element thereof; and an unwinding machine 14 that unwinds the continuous medium P to the side of the printing machine 12, and the unwinding machine 14 is disposed on the right side of the printing machine 12. The image forming apparatus 10 includes a winding machine 16 that winds the continuous medium P, on which an image has been formed (printed), from the side of the printing machine 12, and the winding machine 16 is disposed on the left side of the printing machine 12.

The unwinding machine 14 includes an unwinding machine main body 18 having a housing shape, and an unwinding shaft 20 that supports the continuous medium P in a roll shape is rotatably provided in the unwinding machine main body 18. An unwinding motor (not illustrated) for rotating the unwinding shaft 20 is provided at an appropriate position of the unwinding machine main body 18. A plurality of input roller pairs 22 for inputting the continuous medium P to the side of the printing machine 12 is rotatably provided in the unwinding machine main body 18. The continuous medium P can be unwound to the side of the printing machine 12 by rotating the unwinding shaft 20 by the driving of the unwinding motor.

The winding machine 16 includes a winding machine main body 24 having a housing shape, and a winding shaft 26 which supports the continuous medium P, on which an image has been formed, in a roll shape is rotatably provided in the winding machine main body 24. A winding motor (not illustrated) that rotates the winding shaft 26 is provided at an appropriate position of the winding machine main body 24. A plurality of output roller pairs 28 for outputting the continuous medium P, on which an image has been formed, from the side of the printing machine 12 is rotatably provided in the winding machine main body 24. The continuous medium P on which an image has been formed can be wound from the side of the printing machine 12 by rotating the winding shaft 26 by the driving of the winding motor.

As illustrated in FIGS. 1 and 2, the printing machine 12 includes a printing machine main body 30 having a housing shape, and an image former 32 that forms an image based on image data included in a print job is provided in an upper portion of the printing machine main body 30. The image former 32 includes five image forming units 34W, 34Y, 34M, 34C, and 34K for forming an image with color toners of W (white), Y (yellow), M (magenta), C (cyan), and K (black). The image forming units 34W, 34Y, 34M, 34C, and 34K for W, Y, M, C, and K components are arranged along the up-down direction.

The image forming apparatus 10 forms an images with five toners of a white toner, a yellow toner, a magenta toner, a cyan toner, and a black toner. In other words, the image forming apparatus 10 forms an image with standard color toners of four colors (the yellow toner, the magenta toner, the cyan toner, and the black toner) and the white toner, which is a special toner other than the standard color toners of the four colors. Note that, the image forming apparatus 10 may form an image by using another special toner such as a clear toner instead of the white toner. The image forming apparatus 10 may form an image with the standard color toners of the four colors.

The image forming units 34W, 34Y, 34M, 34C, and 34K for the W, Y, M, C, and K components have a similar configuration. For convenience of illustration and description, common constituent elements are denoted by the same reference signs, and in a case where the common constituent elements are distinguished from each other, a reference sign is indicated by adding W, Y, M, C, or K thereto. In FIG. 1, reference signs are attached to only the constituent elements of the image forming units 34W and 34Y for the W and Y components, and reference signs are omitted for the constituent elements of the other image forming units 34M, 34C, and 34K.

The image forming unit 34 includes a photoreceptor drum 36, and includes an electric charger 38, an exposer (scanning optical apparatus) 40, a developer 42, and a drum cleaner 44 which are disposed around the photoreceptor drum 36.

The photoreceptor drum 36 is, for example, a negatively charged organic photo-conductor (OPC) in which an undercoat layer (UCL), a charge generation layer (CGL), and a charge transport layer (CTL) are sequentially laminated on a circumferential surface of a conductive cylindrical body made of aluminum. The photoreceptor drum 36 rotates at a constant circumferential speed by the driving of a rotation motor (not illustrated).

The electric charger 38 uniformly negatively charges the outer peripheral surface of the photoreceptor drum 36. The exposer 40 emits laser light as scanning light to scan the outer circumferential surface of the photoreceptor drum 36 while exposing the outer circumferential surface of the photoreceptor drum 36, thereby forming an electrostatic latent image on the outer circumferential surface of the photoreceptor drum 36. The amount of light of the laser light emitted from the exposer 40 is modulated according to image data in each color of WYMCK.

The developer 42 is, for example, a developer of a two-component developing system. The developer 42 visualizes the electrostatic latent image on the outer circumferential surface of the photoreceptor drum 36 by attaching the toner of each color component to the outer circumferential surface of the photoreceptor drum 36 to form a toner image. Further, the drum cleaner 44 cleans transfer residual toner remaining on the outer peripheral surface of the photoreceptor drum 36 after the primary transfer. The drum cleaner 44 includes a drum cleaning blade or the like that comes into sliding contact with the outer circumferential surface of the photoreceptor drum 36.

As illustrated in FIGS. 1 and 2, an intermediate transfer unit 46 for transferring a toner image to the continuous medium P is provided in the upper portion of the printing machine main body 30. The intermediate transfer unit 46 includes an intermediate transfer belt 48 having an endless shape, a plurality of support rollers 50, a primary transfer roller 52, a secondary transfer roller 54, and a belt cleaner 56.

The intermediate transfer belt 48 extends in the up-down direction and is stretched around the plurality of support rollers 50. The intermediate transfer belt 48 circulates and runs by the rotation of the plurality of support rollers 50. At least one support roller 50 of the plurality of support rollers 50 is constituted by a driving roller coupled to a rotation motor (not illustrated), and the other support rollers 50 are constituted by a driven roller (free roller).

The primary transfer roller 52 is disposed on the side of the inner peripheral surface of the intermediate transfer belt 48 so as to face the photoreceptor drum 36 of each color component. The primary transfer roller 52 cooperates with the photoreceptor drum 36 to hold the intermediate transfer belt 48 therebetween. A primary transfer nip CN for transferring toner images from the photoreceptor drum 36 to the intermediate transfer belt 48 is formed between the outer peripheral surface of the primary transfer roller 52 and the outer peripheral surface of the photoreceptor drum 36.

The secondary transfer roller 54 is disposed on the side of the outer peripheral surface of the intermediate transfer belt 48 so as to face a predetermined support roller 50. The secondary transfer roller 54 cooperates with the predetermined support roller 50 to hold the intermediate transfer belt 48 therebetween. A secondary transfer nip TN for transferring toner images from the intermediate transfer belt 48 to the continuous medium P is formed between the outer peripheral surface of the secondary transfer roller 54 and the outer peripheral surface of the predetermined support roller 50.

When the intermediate transfer belt 48 passes through the primary transfer nip CN, the toner images on the photoreceptor drums 36 are sequentially superimposed and primarily transferred onto the intermediate transfer belt 48. Specifically, the toner images are electrostatically transferred onto the intermediate transfer belt 48 by applying primary transfer bias to the primary transfer roller 52, and applying electric charge with a polarity opposite to that of the toner to the side of the rear surface of the intermediate transfer belt 48 (the side on which the intermediate transfer belt 48 abuts on the primary transfer roller 52).

Thereafter, when the continuous medium P passes through the secondary transfer nip TN, the toner images on the intermediate transfer belt 48 are secondarily transferred to the continuous medium P. Specifically, the toner images are electrostatically transferred onto the continuous medium P by applying secondary transfer bias to the secondary transfer roller 54, and applying electric charge with a polarity opposite to that of the toner to the side of the rear surface of the continuous medium P (the side on which the continuous medium P abuts on the secondary transfer roller 54), and an image can be formed on the continuous medium P.

The belt cleaner 56 removes transfer residual toner remaining on the surface of the intermediate transfer belt 48 after the secondary transfer. The belt cleaner 56 includes a cleaning blade that comes into sliding contact with the surface of the intermediate transfer belt 48.

As illustrated in FIGS. 1 and 3, a fixer 58 that heats and fixes a toner image formed on the continuous medium P is provided on the side of the exit of the secondary transfer nip TN in the printing machine main body 30. The fixer 58 includes a heating roller 60, a fixing roller 62, a fixing belt 64 having an endless shape, a pressure roller 66, and a temperature sensor 68.

The heating roller 60 is disposed leftward from the intermediate transfer belt 48. The heating roller 60 includes a hollow cylindrical core metal made of, for example, aluminum, iron, stainless steel (SUS), or the like, and a heating apparatus, such as a halogen lamp, for example, provided inside the core metal.

The fixing roller 62 is disposed at a position facing the heating roller 60. The fixing roller 62 includes: a hollow cylindrical core metal made of, for example, aluminum, iron, SUS, or the like; an elastic layer 62e provided on the outer circumferential surface of the core metal and made of, for example, silicone rubber or the like; and a surface layer laminated on the surface of the elastic layer 62e and made of, for example, polytetrafluoroethylene (PTFE) or the like. The elastic layer 62e of the fixing roller 62 is an elastic member that comes into indirect contact with the continuous medium P via the surface layer of the fixing roller 62 and the fixing belt 64.

The fixing belt 64 is stretched around the heating roller 60 and the fixing roller 62. The fixing belt 64 includes: a base material made of, for example, polyimide resin or the like; an elastic layer laminated on the surface of the base material and made of, for example, silicone rubber or the like; and a surface layer laminated on the surface of the elastic layer and made of, for example, polytetrafluoroethylene (PFA) or the like.

The pressure roller 66 is disposed at a position facing the fixing roller 62 outside the fixing belt 64. The pressure roller 66 comes into pressure contact with the fixing roller 62 via the fixing belt 64 under a predetermined fixing load. The pressure roller 66 is configured to be able to come into pressure contact with and separate from the fixing roller 62. The pressure roller 66 rotates by the driving of a rotation motor (not illustrated). The pressure roller 66 includes: a hollow cylindrical core metal made of, for example, aluminum, iron, SUS, or the like; an elastic layer 66e provided on the outer peripheral surface of the core metal and made of, for example, silicone rubber or the like; and a surface layer provided on the surface of the elastic layer 66e and made of, for example, a PFA tube or the like. The elastic layer 66e of the pressure roller 66 is an elastic member that comes into indirect contact with the continuous medium P via the surface layer of the pressure roller 66. The elastic layer 66e of the pressure roller 66 may come into direct contact with the continuous medium P by omitting the surface layer of the pressure roller 66.

A fixing nip FN for conveying the continuous medium P while heating and pressurizing the continuous medium P is formed between the fixing roller 62 and the pressure roller 66. Further, the temperature sensor 68 is disposed at a position facing the heating roller 60. The temperature sensor 68 detects the temperature of the heating roller 60 (fixing belt 64).

When the pressure roller 66 rotates by the driving of a rotation motor, the fixing belt 64 is driven to circulate. As the fixing belt 64 circulates, the heating roller 60 and the fixing roller 62 are driven to rotate. Thus, the toner images can be fixed on the continuous medium P by conveying the continuous medium P while heating and pressurizing the continuous medium P at the fixing nip FN.

A plurality of conveyance roller pairs 70 for conveying the continuous medium P in the conveyance direction via the secondary transfer nip TN and the fixing nip FN is rotatably provided in the printing machine main body 30.

In order to remove ultra fine particles (UFP) generated from the elastic layer 62e of the fixing roller 62 and the elastic layer 66e of the pressure roller 66, the image forming apparatus 10 adopts the following configuration. The ultra fine particles are, for example, metal or ceramic particles having a diameter of 0.1 μm or less, and each particle is an aggregate of several hundred or more atoms.

As illustrated in FIGS. 3 and 4, a first opening 72 having a rectangular shape is formed in a wall portion on the side of the rear surface of the printing machine main body 30. As a first collector that collects ultra fine particles, a first filter 74 is provided on the side of the first opening 72 in the wall portion on the side of the rear surface of the printing machine main body 30. The first filter 74 covers the first opening 72, and is configured to be replaceably attachable to and detachable from the wall portion on the side of the rear surface of the printing machine main body 30.

On the side of the exit of the first filter 74 in the wall portion on the rear side of the printing machine main body 30, a plurality of first air blowing fans 76 as a first air blower that generates an air current toward the side of the first filter 74 around the fixer 58 is provided via a bracket or the like. The plurality of first air blowing fans 76 sucks air around the fixer 58 to the side of the first filter 74. In other words, the plurality of first air blowing fans 76 sucks ultra fine particles included in air around the fixer 58 to the side of the first filter 74. The output mode of the plurality of first air blowing fans 76 as the first air blower is configured to be switchable among a low output mode, a first high output mode, and a second high output mode. The output mode of the first air blower can be switched by changing the number of first air blowing fans 76 to be driven or the rotation speed of the first air blowing fans 76.

The low output mode in the first air blower (the plurality of first air blowing fans 76) is an output mode of 40% or less (for example, 30%) of the maximum output of the plurality of first air blowing fans 76. The first high output mode in the first air blower is an output mode higher than the low output mode, and is an output mode of 70% or more (for example, 100%) of the maximum output of the plurality of first air blowing fans 76. The second high output mode in the first air blower is an output mode lower than the first high output mode and is an output mode of 70% or more (for example, 80%) of the maximum output of the plurality of first air blowing fans 76.

As illustrated in FIGS. 1, 2, and 5, a second opening 78 having a rectangular shape is formed at a position corresponding to each of the image forming units 34W, 34Y, 34M, 34C, and 34K in a wall portion on the side of the front surface of the printing machine main body 30. A second filter 80 as a second collector that collects ultra fine particles is provided on the side of each second opening 78 in the wall portion on the side of the front surface of the printing machine main body 30. Each second filter 80 covers each second opening 78, and is configured to be replaceably attachable to and detachable from the wall portion on the side of the front surface of the printing machine main body 30.

On the side of the exit of each second filter 80 in the wall portion on the side of the front surface of the printing machine main body 30, a second air blowing fan 82 as a second air blower that generates an air current toward the side of each second filter 80 around each image forming unit 34 is provided via a bracket or the like. Each second air blowing fan 82 sucks air around each image forming unit 34 to the side of the second filter 80. In other words, each second air blowing fan 82 sucks ultra fine particles included in air around each image forming unit 34 to the side of the second filter 80. Each second air blowing fan 82 ejects air (clean air) cleaned by each second filter 80. The output mode of each second air blowing fan 82 as the second air blower is configured to be switchable among a low output mode, a first high output mode, and a second high output mode. The output mode of the second air blower can be switched by changing the rotation speed of each second air blowing fan 82.

The low output mode in the second air blower (the plurality of second air blowing fans 82) is an output mode of 40% or less (for example, 30%) of the maximum output of the plurality of second air blowing fans 82. The first high output mode in the second air blower is an output mode higher than the low output mode, and is an output mode of 70% or more (for example, 100%) of the maximum output of the plurality of second blowing fans 82. The second high output mode in the second blowing part is an output mode lower than the first high output mode, and is an output mode of 70% or more (for example, 80%) of the maximum output of the plurality of second blowing fans 82.

As illustrated in FIGS. 2 and 5, a supply duct 84 that supplies the clean air ejected from each second air blowing fan 82 to a charged electrode of each electric charger 38 is provided below each developer 42, and each supply duct 84 extends in the front-rear direction along each electric charger 38. Each supply duct 84 is connected to the ejection side of each second air blowing fan 82 via a communication pipe 86.

Either the first filter 74 as the first collector and the plurality of second filters 80 as the second collector may be omitted from the configuration of the image forming apparatus 10. In a case where the first filter 74 is omitted, the plurality of first air blowing fans 76 as the first air blower is omitted. In a case where the plurality of second filters 80 is omitted, the plurality of second blowing fans 82 as the second air blower, the plurality of supply ducts 84, and the plurality of communication pipes 86 are omitted.

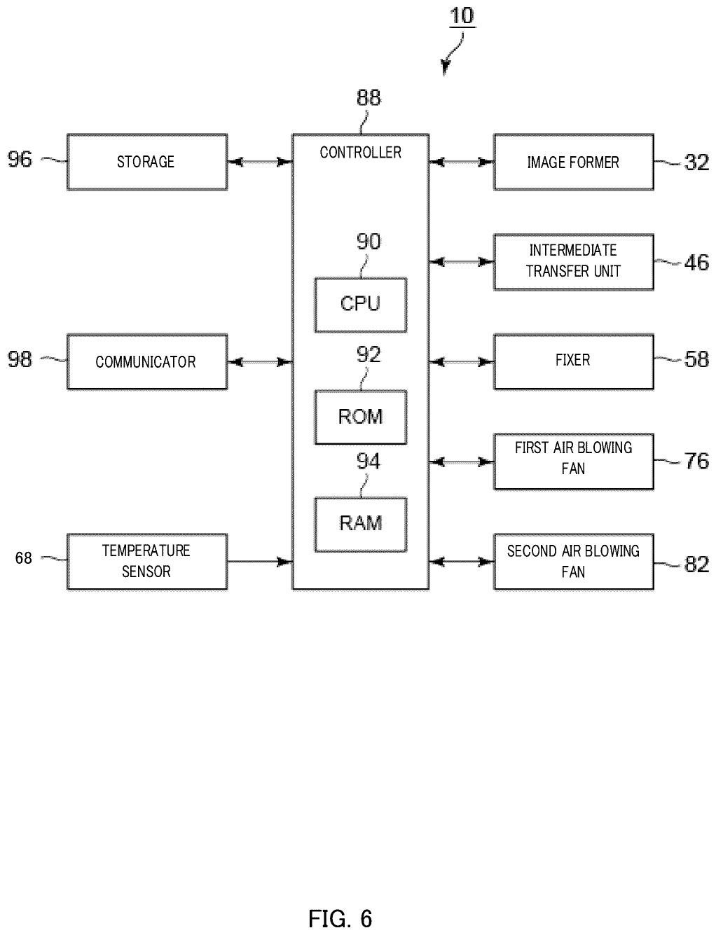

A control configuration of the image forming apparatus 10 according to the present embodiment will be described with reference to FIG. 6. FIG. 6 is a control block diagram of the image forming apparatus 10 according to the present embodiment.

As illustrated in FIG. 6, the image forming apparatus 10 includes a controller 88 that controls the image former 32, the intermediate transfer unit 46, the fixer 58, the plurality of first air blowing fans 76, the plurality of second air blowing fans 82, and the like. The controller 88 plays a role in managing control of the image forming apparatus 10 in its entirety. The controller 88 includes a central processing unit (CPU) 90, a random access memory (RAM) 92, and a read only memory (ROM) 94. A storage 96 and a communicator 98 are connected to the controller 88.

The CPU 90 comprehensively controls the entire operation of the image forming apparatus 10. The CPU 90 reads various control programs and setting data stored in the ROM 92, develops the read control programs and setting data in the RAM 94, and executes the programs to perform various pieces of arithmetic processing. The RAM 94 provides a working memory space for the CPU 90 and stores temporary data. Further, when the CPU 90 performs various pieces of arithmetic processing, the CPU 90 refers to various kinds of data stored in the storage 96. The storage 96 is configured by, for example, a non-volatile semiconductor memory or a hard disk drive.

The controller 88 transmits and receives various kinds of data to and from an external apparatus (for example, a personal computer) connected to a communication network such as a local area network (LAN) or a wide area network (WAN) via the communicator 98. The controller 88 receives, for example, a print job transmitted from the external apparatus, and causes a toner image to be formed on the continuous medium P based on image data (input image data) included in the print job. The communicator 98 is constituted by, for example, a communication control card such as a LAN card.

The temperature sensor 68 is connected to the controller 88. The controller 88 monitors the temperature of the heating roller 60 in the fixer 58. In addition, the controller 88 (the CPU 90) has the following configuration by executing various control programs.

As illustrated in FIG. 6, the controller 88 varies the output mode of the plurality of first air blowing fans 76 as the first air blower and the plurality of second blowing fans 82 as the second air blower according to at least one of an apparatus state of the image forming apparatus 10 and/or a printing condition (image forming condition) for the image forming apparatus 10. Further, the controller 88 may vary the output mode of only either the plurality of first air blowing fans 76 or the plurality of second air blowing fans 82 according to the apparatus state of the image forming apparatus 10 or the like.

The apparatus state of the image forming apparatus 10 includes whether image formation is in progress (printing is in progress). In a case where image formation is in progress as the apparatus state of the image forming apparatus 10, the controller 88 sets the output mode of the plurality of first air blowing fans 76 as the first air blower and the second blowing fan 82 as the second air blower to a high output mode. The high output mode includes the first high output mode and the second high output mode as described above. In a case where image formation is in progress as the apparatus state of the image forming apparatus 10, the controller 88 sets the output mode of the plurality of first air blowing fans 76 and the plurality of second air blowing fans 82 to one of the first high output mode and the second high output mode. In a case where image formation is not in progress as the apparatus state of the image forming apparatus 10, the controller 88 sets the output mode of the plurality of first air blowing fans 76 and the plurality of second air blowing fans 82 to the low output mode. The case where image formation is not in progress as the apparatus state of the image forming apparatus 10 means a case of being idling.

As illustrated in FIGS. 3 and 6, the apparatus state of the image forming apparatus 10 includes the temperature of the heating roller 60 in the fixer 58. In a case where the temperature of the heating roller 60 is equal to or higher than a predetermined temperature, the controller 88 may set the output mode of the plurality of first air blowing fans 76 and the plurality of second air blowing fans 82 to one of the first high output mode and the second high output mode. In a case where the temperature of the heating roller 60 is less than the predetermined temperature, the controller 88 may set the output mode of the plurality of first air blowing fans 76 and the plurality of second air blowing fans 82 to the low output mode. The predetermined temperature is a temperature serving as a reference for switching the output mode of the plurality of first air blowing fans 76 and the plurality of second air blowing fans 82 to the high output mode, and is, for example, 195° C. in the present embodiment. Note that, whether the temperature of the heating roller 60 is equal to or higher than the predetermined temperature corresponds to whether image formation is in progress as the apparatus state of the image forming apparatus 10.

The apparatus state of the image forming apparatus 10 includes whether the fixing roller 62 and the pressure roller 66 in the fixer 58 are separated from each other. In a case where the fixing roller 62 and the pressure roller 66 are separated from each other, the controller 88 may set the output mode of the plurality of first air blowing fans 76 and the plurality of second blowing fans 82 to the low output mode. In a case where the fixing roller 62 and the pressure roller 66 are not separated from each other, the controller 88 may set the output mode of the plurality of first air blowing fans 76 and the plurality of second air blowing fans 82 to one of the first high output mode and the second high output mode. Note that, whether the fixing roller 62 and the pressure roller 66 are separated from each other corresponds to whether it is idling.

As illustrated in FIG. 6, a plurality of the printing conditions includes a printing distance (image forming distance) for forming an image along the longitudinal direction of the continuous medium P. The controller 88 varies the output mode of the plurality of first air blowing fans 76 and the plurality of second air blowing fans 82 according to the printing distance under a predetermined condition. The controller 88 may set the output mode of the plurality of first air blowing fans 76 and the plurality of second air blowing fans 82 to the first high output mode in a case where the printing distance is equal to or greater than a predetermined distance under the predetermined condition. The controller 88 temporarily sets the output mode of the plurality of first air blowing fans 76 and the plurality of second air blowing fans 82 to the second high output mode in a case where the printing distance is less than the predetermined distance under the predetermined condition. The predetermined condition means that image formation is in progress as the apparatus state of the image forming apparatus 10, or refers to a corresponding state corresponding thereto. The corresponding state means that the temperature of the heating roller 60 is equal to or higher than the predetermined temperature, or that the fixing roller 62 and the pressure roller 66 are not separated from each other. The predetermined distance means a distance serving as a reference for switching the output mode of the plurality of first air blowing fans 76 and the plurality of second air blowing fans 82 to the first high output mode, and is, for example, 300 m in the present embodiment.

The plurality of printing conditions includes whether toners of five or more colors are used for image formation (printing). The controller 88 may vary the output mode of the plurality of first air blowing fans 76 and the plurality of second air blowing fans 82 according to whether the toners of five or more colors are used for the image formation under the predetermined condition. The controller 88 may set the output mode of the plurality of first air blowing fans 76 and the plurality of second air blowing fans 82 to the first high output mode in a case where the toners of five or more colors are used for the image formation under the predetermined condition. In a case where the toners of five or more colors are not used for the image formation under the predetermined condition, the controller 88 may set the output mode of the plurality of first air blowing fans 76 and the plurality of second air blowing fans 82 to the first high output mode.

The plurality of printing conditions includes the toner adhesion amount per unit area of the continuous medium P. The controller 88 varies the output mode of the plurality of first air blowing fans 76 and the plurality of second air blowing fans 82 according to the toner adhesion amount per unit area of the continuous medium P under the predetermined condition. The controller 88 sets the output mode of the plurality of first air blowing fans 76 and the plurality of second air blowing fans 82 to the first high output mode in a case where the toner adhesion amount per unit area of the continuous medium P is equal to or greater than a predetermined adhesion amount under the predetermined condition. The controller 88 may set the output mode of the plurality of first air blowing fans 76 and the plurality of second air blowing fans 82 to the second high output mode in a case where the toner adhesion amount per unit area of the continuous medium P is less than the predetermined adhesion amount under the predetermined condition. The predetermined adhesion amount is an adhesion amount serving as a reference for switching the output mode of the plurality of first air blowing fans 76 and the plurality of second air blowing fans 82 to the first high output mode, and is, for example, an adhesion amount equal to or greater than half the maximum adhesion amount per unit area of the continuous medium P in the present embodiment.

The plurality of printing conditions includes whether a special toner such as the white toner is used for image formation. The controller 88 varies the output mode of the plurality of first air blowing fans 76 and the plurality of second air blowing fans 82 according to whether a special toner is used for image formation under the predetermined condition. The controller 88 sets the output mode of the plurality of first air blowing fans 76 and the plurality of second air blowing fans 82 to the first high output mode in a case where a special toner is used for the image formation under the predetermined condition. The controller 88 may set the output mode of the plurality of first air blowing fans 76 and the plurality of second air blowing fans 82 to the second high output mode in a case where a special toner is not used for the image formation under the predetermined condition. The controller 88 may set the output mode of the plurality of first air blowing fans 76 and the plurality of second air blowing fans 82 to the first high output mode in a case where a special toner is not used for the image formation under the predetermined condition.

The plurality of printing conditions includes whether the continuous medium P is a special medium such as tack paper or a PET film. The controller 88 varies the output mode of the plurality of first air blowing fans 76 and the plurality of second blowing fans 82 according to whether the continuous medium P is the special medium under the predetermined condition. The controller 88 may set the output mode of the plurality of first air blowing fans 76 and the plurality of second blowing fans 82 to the first high output mode in a case where the continuous medium P is the special medium under the predetermined condition. The controller 88 temporarily sets the output mode of the plurality of first air blowing fans 76 and the plurality of second blowing fans 82 to the second high output mode in a case where the continuous medium P is not the special medium under the predetermined condition.

The plurality of printing conditions includes the thickness of the continuous medium P. The controller 88 may vary the output mode of the plurality of first air blowing fans 76 and the plurality of second air blowing fans 82 according to the thickness of the continuous medium P under the predetermined condition. The controller 88 may set the output mode of the plurality of first air blowing fans 76 and the plurality of second blowing fans 82 to the first high output mode in a case where the thickness of the continuous medium P is equal to or greater than a predetermined thickness under the predetermined condition. The controller 88 may set the output mode of the plurality of first air blowing fans 76 and the plurality of second air blowing fans 82 to the second high output mode in a case where the thickness of the continuous medium P is less than the predetermined thickness under the predetermined condition. The predetermined thickness is a thickness serving as a reference for switching the output mode of the plurality of first air blowing fans 76 and the plurality of second air blowing fans 82 to the first high output mode, and is, for example, 200 μm in the present embodiment.

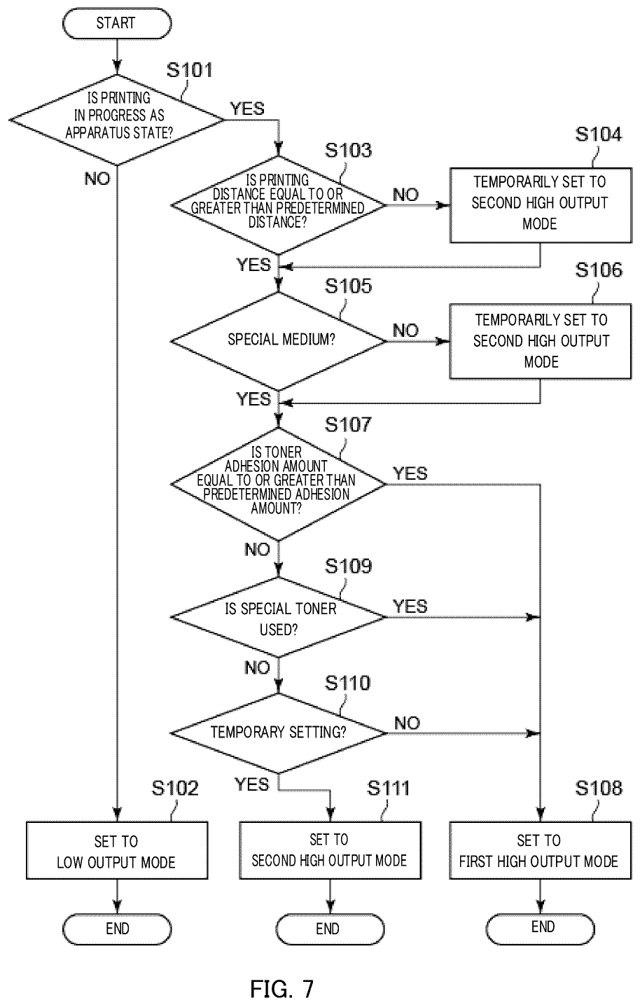

Setting processing of the output mode of the plurality of first air blowing fans 76 and the plurality of second air blowing fans 82 will be described with reference to FIG. 7. FIG. 7 is a flowchart for describing the setting processing of the output mode of the plurality of first air blowing fans 76 and the plurality of second air blowing fans 82.

The controller 88 determines whether image formation is in progress as the apparatus state of the image forming apparatus 10 (step S101 in FIG. 7). In a case where image formation is not in progress as the apparatus state of the image forming apparatus 10 (NO in step S101 in FIG. 7), the controller 88 sets the plurality of first air blowing fans 76 and the plurality of second air blowing fans 82 to the low output mode (step S102 in FIG. 7).

In a case where image formation is in progress as the apparatus state of the image forming apparatus 10 (YES in step S101 in FIG. 7), the controller 88 determines whether the printing distance is equal to or greater than the predetermined distance (step S103 in FIG. 7). In a case where the printing distance is less than the predetermined distance (NO in step S103 in FIG. 7), the controller 88 temporarily sets the plurality of first air blowing fans 76 and the plurality of second air blowing fans 82 to the second high output mode (step S104 in FIG. 7).

In a case where the printing distance is equal to or greater than the predetermined distance (YES in step S103 in FIG. 7), the controller 88 determines whether the continuous medium P is the special medium (step S105 in FIG. 7). In a case where the continuous medium P is not the special medium (NO in step S105 in FIG. 7), the controller 88 temporarily sets the output mode of the plurality of first air blowing fans 76 and the plurality of second air blowing fans 82 to the second high output mode (step S106 in FIG. 7). In a case where the continuous medium P is the special medium (YES in step S105 in FIG. 7), the controller 88 determines whether the toner adhesion amount per unit area of the continuous medium P is equal to or greater than the predetermined adhesion amount (step S107 in FIG. 7). In a case where the toner adhesion amount is equal to or greater than the predetermined adhesion amount (YES in step S107 in FIG. 7), the controller 88 sets the output mode of the plurality of first air blowing fans 76 and the plurality of second air blowing fans 82 to the first high output mode (step S108 in FIG. 7).

In a case where the toner adhesion amount is less than the predetermined adhesion amount (NO in step S107 in FIG. 7), the controller 88 determines whether a special toner is used for the image formation (step S109 in FIG. 7). In a case where a special toner is used (YES in step S109 in FIG. 7), the controller 88 sets the output mode of the plurality of first air blowing fans 76 and the plurality of second air blowing fans 82 to the first high output mode (step S108 in FIG. 7).

In a case where a special toner is not used (NO in step S109 in FIG. 7), the controller 88 determines whether the output mode of the plurality of first air blowing fans 76 and the plurality of second air blowing fans 82 has been temporarily set to the second high output mode (step S110 in FIG. 7). In a case where the second high output mode has been temporarily set (YES in step S110 in FIG. 7), the controller 88 sets the output mode of the plurality of first air blowing fans 76 and the plurality of second air blowing fans 82 to the second high output mode (step S111 in FIG. 7). In a case where the second high output mode has not been temporarily set (NO in step S110 in FIG. 7), the controller 88 sets the output mode of the plurality of first air blowing fans 76 and the plurality of second air blowing fans 82 to the first high output mode (step S108 in FIG. 7).

Note that, the setting processing of the output mode of the plurality of first air blowing fans 76 and the plurality of second air blowing fans 82 described above is an example, and may be changed as appropriate.

According to the configuration of the image forming apparatus 10 according to the present embodiment, ultra fine particles included in air around the fixer 58 are collected by the first filter 74 by driving the plurality of first air blowing fans 76 to generate an air current toward the side of the first filter 74 around the fixer 58. In addition, ultra fine particles included in air around each image forming unit 34 are collected by each second filter 80 by driving each second air blowing fan 82 to generate an air current toward the side of each second filter 80 around each image forming unit 34. Accordingly, the present embodiment makes it possible to form a high-quality image on the continuous medium P by removing ultra fine particles which cause image streaks and image unevenness.

According to the configuration of the image forming apparatus 10 according to the present embodiment, the controller 88 varies the output mode of the plurality of first air blowing fans 76 and the plurality of second blowing fans 82 according to at least one of the apparatus state of the image forming apparatus 10 and/or the printing condition for the image forming apparatus 10. For this reason, the output of the plurality of first air blowing fans 76 and the plurality of second air blowing fans 82 does not become excessively high and is set (adjusted) to an output corresponding to at least one of the apparatus state of the image forming apparatus 10 and/or the printing condition for the image forming apparatus 10. Accordingly, the present embodiment makes it possible to attempt a noise reduction in the image forming apparatus 10 by suppressing the fan noise of the plurality of first air blowing fans 76 and the like as well as attempt energy saving for the image forming apparatus 10 by suppressing the power consumption of the plurality of first air blowing fans 76 and the like.

In addition, according to the configuration of the image forming apparatus 10 according to the present embodiment, the controller 88 sets the output mode of the plurality of first air blowing fans 76 and the like to the low output mode in a case where image formation is not in progress as the apparatus state of the image forming apparatus 10. For this reason, the present embodiment makes it possible to sufficiently suppress the fan noise and the power consumption of the plurality of first air blowing fans 76 and the like to promote a noise reduction in and energy saving for the image forming apparatus 10 in a case where image formation is not in progress as the apparatus state of the image forming apparatus 10.

According to the configuration of the image forming apparatus 10 according to the present embodiment, the controller 88 sets the output mode of the plurality of first air blowing fans 76 and the like to the low output mode in a case where the temperature of the heating roller 60 is less than the predetermined temperature. For this reason, the present embodiment makes it possible to sufficiently suppress the fan noise and the power consumption of the plurality of first air blowing fans 76 and the like to promote a noise reduction in and energy saving for the image forming apparatus 10 in a case where the temperature of the heating roller 60 is less than the predetermined temperature.

According to the configuration of the image forming apparatus 10 according to the present embodiment, the controller 88 sets the output mode of the plurality of first air blowing fans 76 and the plurality of second air blowing fans 82 to the low output mode in a case where the fixing roller 62 and the pressure roller 66 are separated from each other. For this reason, the present embodiment makes it possible to sufficiently suppress the fan noise and the power consumption of the plurality of first air blowing fans 76 and the like to promote a noise reduction in and energy saving for the image forming apparatus 10 in a case where the fixing roller 62 and the pressure roller 66 are separated from each other.

In addition, according to the configuration of the image forming apparatus 10 according to the present embodiment, the controller 88 varies the output mode of the plurality of first air blowing fans 76 and the like according to the printing distance. For this reason, the present embodiment makes it possible to sufficiently suppress the fan noise and the power consumption of the plurality of first air blowing fans 76 and the like to promote a noise reduction in and energy saving for the image forming apparatus 10 in a case where the printing distance is less than the predetermined distance.

According to the configuration of the image forming apparatus 10 according to the present embodiment, the controller 88 varies the output mode of the plurality of first air blowing fans 76 and the like according to whether the toners of five or more colors are used for the image formation under the predetermined condition. For this reason, the present embodiment makes it possible to sufficiently suppress the fan noise and the power consumption of the plurality of first air blowing fans 76 and the like to promote a noise reduction in and energy saving for the image forming apparatus 10 in a case where the toners of five or more colors are not used for the image formation.

According to the configuration of the image forming apparatus 10 according to the present embodiment, the controller 88 varies the output mode of the plurality of first air blowing fans 76 and the like according to the toner adhesion amount per unit area of the continuous medium P. For this reason, the present embodiment makes it possible to sufficiently suppress the fan noise and the power consumption of the plurality of first air blowing fans 76 and the like to promote a noise reduction in and energy saving for the image forming apparatus 10 in a case where the toner adhesion amount is less than the predetermined adhesion amount.

According to the configuration of the image forming apparatus 10 according to the present embodiment, the controller 88 varies the output mode of the plurality of first air blowing fans 76 and the like according to whether a special toner is used for the image formation. For this reason, the present embodiment makes it possible to sufficiently suppress the fan noise and the power consumption of the plurality of first air blowing fans 76 and the like to promote a noise reduction in and energy saving for the image forming apparatus 10 in a case where a special toner is not used.

According to the configuration of the image forming apparatus 10 according to the present embodiment, the controller 88 varies the output mode of the plurality of first air blowing fans 76 and the like according to whether the continuous medium P is the special medium. For this reason, the present embodiment makes it possible to sufficiently suppress the fan noise and the power consumption of the plurality of first air blowing fans 76 and the like to promote a noise reduction in and energy saving for the image forming apparatus 10 in a case where the continuous medium P is not the special medium.

According to the configuration of the image forming apparatus 10 according to the present embodiment, the controller 88 varies the output mode of the plurality of first air blowing fans 76 and the like according to the thickness of the continuous medium P. For this reason, the present embodiment makes it possible to sufficiently suppress the fan noise and the power consumption of the plurality of first air blowing fans 76 and the like to promote a noise reduction in and energy saving for the image forming apparatus 10 in a case where the thickness of the continuous medium P is less than the predetermined thickness.

Although the present embodiment has been specifically described above, the present invention is not limited to the above-described specific embodiment. Various modifications and changes can be made to the specific examples described in the above embodiment within the scope of the spirit of the present invention described in the claims.

Although embodiments of the present invention have been described and illustrated in detail, it is clearly understood that the same is by way of illustration and example only and not limitation, the scope of the present invention should be interpreted by terms of the appended claims.

What is claimed is:

1. An image forming apparatus that forms an image on a continuous medium, the image forming apparatus comprising:
a fixer that includes an elastic member and heats and fixes a toner image formed on the continuous medium, the elastic member coming into in direct or indirect contact with the continuous medium;
a collector that collects ultra fine particles generated from the elastic member;
an air blower that generates an air current toward a side of the collector; and
a hardware processor that varies an output mode of the air blower according to at least one of an apparatus state of the image forming apparatus and/or a printing condition for the image forming apparatus.

2. The image forming apparatus according to claim 1, wherein:
the apparatus state includes whether image formation is in progress, and
the hardware processor is sets, in a case where the image formation is in progress as the apparatus state, the output mode of the air blower to a high output mode, and sets, in a case where the image formation is not in progress as the apparatus state, the output mode of the air blower to a low output mode.

3. The image forming apparatus according to claim 1, wherein:
the apparatus state includes a temperature of the fixer, and
the hardware processor sets, in a case where the temperature of the fixer is equal to or higher than a predetermined temperature, the output mode of the air blower to a high output mode, and sets, in a case where the temperature of the fixer is less than the predetermined temperature, the output mode of the air blower to a low output mode, the predetermined temperature serving as a reference for switching the output mode of the air blower to the high output mode.

4. The image forming apparatus according to claim 1, wherein:
a plurality of the printing conditions includes a printing distance for forming the image along a longitudinal direction of the continuous medium, and
the hardware processor varies the output mode of the air blower according to the printing distance.

5. The image forming apparatus according to claim 1, wherein:
a plurality of the printing conditions includes whether toners of five or more colors are used for image formation, and
the hardware processor varies the output mode of the air blower according to whether the toners of the five or more colors are used for the image formation.

6. The image forming apparatus according to claim 1, wherein:
a plurality of the printing conditions includes a toner adhesion amount per unit area of the continuous medium, and
the hardware processor varies the output mode of the air blower according to the toner adhesion amount.

7. The image forming apparatus according to claim 1, wherein:
a plurality of the printing conditions includes whether a special toner is used for image formation, and
the hardware processor varies the output mode of the air blower according to whether the special toner is used for the image formation.

8. The image forming apparatus according to claim 7, wherein
the special toner is a white toner.

9. The image forming apparatus according to claim 1, wherein:
a plurality of the printing conditions includes whether the continuous medium is a special medium, and
the hardware processor varies the output mode of the air blower according to whether the continuous medium is the special medium.

10. The image forming apparatus according to claim 9, wherein
the special medium is tack paper.

11. The image forming apparatus according to claim 1, wherein:
a plurality of the printing conditions includes a thickness of the continuous medium, and the hardware processor varies the output mode of the air blower according to the thickness of the continuous medium.

12. The image forming apparatus according to claim 1, wherein:
the apparatus state includes whether a fixing roller and a pressure roller in the fixer are separated from each other, and
the hardware processor sets, in a case where the fixing roller and the pressure roller are separated from each other, the output mode of the air blower to a low output mode, and sets, in a case where the fixing roller and the pressure roller are not separated from each other, the output mode of the air blower to a high output mode.

13. The image forming apparatus according to claim 2, wherein
the high output mode is an output mode in which an output of the air blower is 70% or more of a maximum output of the air blower, and the low output mode is an output mode in which the output of the air blower is 40% or less of the maximum output of the air blower.
